(19) United States
(12) Patent Application Publication
(10) Pub. No.: US 2024/0311520 A1
(43) Pub. Date: Sep. 19, 2024

(54) VERSATILE LATTICE CELL TRANSITIONING FOR ADDITIVELY MANUFACTURED PRODUCTS

(71) Applicant: Carbon, Inc., Redwood City, CA (US)

(72) Inventors: Ruiqi CHEN, Novi, MI (US); Kyle KLOSTER, East Palo Alto, CA (US); Aidan KURTZ, Hayward, CA (US); Robert G. SAGE, Los Altos, CA (US); Weixiong ZHENG, Fremont, CA (US); Hardik KABARIA, Redwood City, CA (US)

(21) Appl. No.: 18/681,208

(22) PCT Filed: Aug. 24, 2022
(86) PCT No.: PCT/US2022/075372

§ 371 Date: Feb. 5, 2024

Related U.S. Application Data
(60) Provisional application No. 63/236,421, filed on Aug. 24, 2021.
(60) Provisional application No. 63/302,787, filed on Jan. 25, 2022.
(60) Provisional application No. 63/311,148, filed on Feb. 17, 2022.

(51) Int. Cl. G06F 30/10; G06F 113/10

(52) U.S. Cl. CPC G06F 30/10; G06F 2113/10

(57) ABSTRACT

Three-dimensional (3D) lattice objects with multiple zones of different lattice unit cells may be formed by additive manufacturing. Sets of primary unit cells are provided such that cach primary unit cell is configured to smoothly transition to other primary unit cells through a series of intermediate unit cells. A universal unit cell may define the primary and intermediate unit cells.

### RELATED APPLICATIONS

This application claims priority to U.S. Provisional Application Ser. Nos. 63/311,148, (filed Feb. 23, 2022), 63/302,787 (filed Jan. 25, 2022), and 63/236,421 (filed Aug. 24, 2021), the disclosures of which are hereby incorporated by reference in their entirety.

### FIELD

Methods and apparatus for producing additively manufactured lattice structures containing multiple lattice types transitioning from one to the other are described, along with the products so made.

### BACKGROUND

Additive manufacturing makes it possible to fabricate a wide variety of geometries that are difficult or impossible to make with legacy manufacturing processes. Lattices in particular have opened up a world of desirable mechanical properties, from better compression and energy absorption properties to lighter weight parts. Popular use cases include replacing standard foam padding with lattices having better stiffness-to-mass ratios, and using superior energy-absorption properties of some lattices to improve protective equipment like helmets and car seats (see. e.g., Kabaria and Kurtz, Lattice transitioning structures in additively manufactured products. PCT Application WO2020/086372 (30 Apr. 2020), see also Kabaria and Kurtz, U.S. Pat. No. 10,882,255 and Bologna et al., US Patent Application Publication Nos. US2020/0215415 and US2020/0100554). With the immense number of different lattice cells available for a large variety of different 3D products, all having different structural, mechanical, and tensile property requirements, there is a need for new approaches to designing lattice-filled articles.

### SUMMARY

Three-dimensional (3D) lattice objects with multiple zones of different lattice unit cells may be formed by additive manufacturing. Sets of primary unit cells are provided such that each primary unit cell is configured to smoothly transition to other primary unit cells through a series of intermediate unit cells. A universal unit cell may define the primary and intermediate unit cells.

The series of intermediate unit cells may be provided by inputting at least two primary unit cells of the set of primary unit cells and interpolating the series of intermediate unit cells. That is, a first function defining a first lattice cell of the set of primary unit cells and a second function defining a second lattice cell of the set of primary unit cells may be received as input to a lattice generation module. A series of interpolated or intermediate unit cells may be generated such that each member of the series represents a successive interpolation or change between the first function and the second function. For example, the intermediate unit cells may be a series of interpolated functions or values between the first and second functions that define the first and second lattice cells. All unit cells may be defined by/definable by a single universal lattice unit cell.

A three-dimensional (3D) representation of the 3D lattice object may include at least first and second zones within the 3D representation. The at least first and second zones may be filled with different ones of the primary or intermediate unit cells with a transition region between the zones. The transition region may be filled with the progressive series of intermediate unit cells that smoothly transition between the primary or intermediate unit cells of the first and second zones. In some embodiments, three or more zones may be provided with corresponding transition regions between the zones. Each zone is filled with different ones of the interconnected units of the primary or intermediate unit cells. The zones are separated by respective transition regions that may be filled with the progressive series of intermediate unit cells that smoothly transition between the primary or intermediate unit cells of the adjacent zones, such as an interpolated series of intermediate unit cells. Again, all unit cells may be defined by/definable by a single universal lattice unit cell.

The progressive series of intermediate (e.g., interpolated) unit cells may smoothly transition between the primary or intermediate unit cells of the adjacent zones such that features or dimensions of the adjacent cells change gradually and/or progressively from one cell to the next in the object. For example, a cell feature and/or dimension, such as a width, length, thickness, curvature, or position of one or more strut(s) or node(s) of the unit cell may be successively modified through the progressive series of intermediate unit cells so that the cell feature increases or decreases through the progressive series without disconnecting or rough transitions between the cells in the progressive series of intermediate unit cells of the transition zone(s). In some embodiments, the struts of the intermediate cells in the progressive series may gradually increase or decrease in length as they approach the (primary or intermediate) unit cell contained in each respective zone, and in conformance with the (primary or intermediate) unit cell contained in each respective zone. As another example, in some embodiments, in the progressive series of intermediate unit cells of the transition region between zones, multiple struts of one cell in the series may successively become closer together throughout the progressive series to collapse directly into one another to form a single strut to smoothly transition from a unit cell in one zone with a given number of struts to a unit cell in the next zone with fewer struts.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 is a schematic illustration of transition pathways between a set of primary lattice unit cells (informally named Rhombic, Tetrahedron, Octahedral, Star, Kagome, and Voronoi, all in solid circles) through intermediate unit cells (dashed circles, one named “Kelvin” for later reference).

FIG. 2 is a flow chart illustrating one embodiment of a process as described herein that resolves the problem noted in connection with FIG. 1 above.

FIG. 3 is a schematic illustration of an apparatus for carrying out a process of FIG. 2.

FIG. 4 illustrates a group of six lattice cells that can be used (along with a truncated octahedron or “Kelvin” cell) as primary unit cells in the processes, lattices, and apparatus described herein. Note names of cells are arbitrary or suggestive, rather than formal.

FIGS. 5A-5D illustrate a universal unit cell that can be used with the primary unit cells noted in connection with FIG. 4 above.

FIG. 6A-6B illustrate a first alternative universal cell.

FIG. 7A-7B illustrate a second alternative universal cell.

FIG. 8A schematically illustrates an object having two zones A, B, and a single transition region AB.

FIG. 8B schematically illustrates an object having three zones A, B, C, and two transition regions AB, BC.

FIG. 9A schematically illustrates an object having three zones A, B, C, and three transition regions AB, BC, and ABC, where the third transition region comprises a progressive series of intermediate unit cells that vary along at least two distinct vectors or dimensions (represented by dashed lines x-x and y-y).

FIG. 9B schematically illustrates another example object having three zones A, B, C, and three transition regions AB, BC, and ABC, where the third transition region comprises a progressive series of intermediate unit cells that vary along at least two distinct vectors or dimensions

FIG. 9C schematically illustrates still another object having three zones A, B, C, and three transition regions AB, BC, and ABC, where the third transition region comprises a progressive series of intermediate unit cells that vary along at least two distinct vectors or dimensions.

FIG. 10: Strut lattice consisting of four nodes (labeled 0 through 3) and six struts (labeled 0 through 5).

FIGS. 11A-11C: Example of three intermediate cells created from the three primary cell types TETRAHEDRAL, OCTAHEDRAL, and KAGOME. (FIG. 11A) Intermediate cell with weight vector (TETRAHEDRAL: 0.25, OCTAHEDRAL: 0.5, KAGOME: 0.25). (FIG. 11B) Intermediate cell with weight vector (TETRAHEDRAL: 0.375, OCTAHEDRAL: 0.125, KAGOME 0.5). (FIG. 11C) Intermediate cell with weight vector (TETRAHEDRAL: 0, OCTAHEDRAL: 0.5, KAGOME 0.5).

FIG. 12: Black lines depict matching face nodes on two adjacent tetrahedrons. The position of node pairs are averaged to facilitate connectivity between adjacent struts. Note: the two adjacent tetrahedrons are deliberately shown separated from each other for clarity.

FIGS. 13A-B: FIG. 13A is a tetrahedron mesh of a triangular region of interest. FIG. 13B Strut lattice structure generated within a triangular region of interest. The corners of the triangular region are assigned weight vectors that correspond to the three primary cell types TETRAHEDRAL, OCTAHEDRAL, and KAGOME, whereas the middle of the triangular region consist of transition lattice cells created by blending all three primary cell types.

FIGS. 14A-14B show a 3D object containing regions with seven different primary lattice unit cells in different zones, all zones transitioning to adjacent zones through intermediate regions filled with intermediate unit cells.

FIG. 15A: Intracellular transition created by assigning Tetrahedral cell type to two vertices and Octahedral cell type to the remaining two vertices.

FIG. 15B: Intracellular transition created by assigning a different cell type to each of the four vertices. Note that the assigned cell type at one vertex can be a weighted combination of multiple primary cell types: For example, the “Weighted Combination” cell in FIG. 15B consists of 50% Octahedral: 20% Rhombic; and 30% Tetrahedral.

FIGS. 16A-16C: The vertices in the tetrahedron mesh shown in (FIG. 16B) are assigned cell types according to the legend in (FIG. 16A), where the “Weighted Combination” cell type consists of 50% Octahedral and 50% Tetrahedral. The resulting lattice generated from the cell type assignments is depicted in (FIG. 16C), showing connectivity between lattice struts at all boundaries.

FIG. 17: Tetrahedron-based primary cell types (top row) are paired with geometrically compatible triangle-based primary cell types (bottom row).

FIG. 18: (Left) Corresponding nodes between two geometrically compatible triangle-based cell type and tetrahedron-based cell type. (Right) Combined cell created by joining corresponding nodes together.

FIG. 19 illustrates seven primary cell types according to some embodiments.

FIG. 20 illustrates hybrid cell types according to some embodiments.

FIG. 21 illustrates a hybrid cell type and a corresponding lattice wristpad formed from the hybrid cell type.

FIG. 22 illustrates transition cells that may be created by assigning four constituent cell types to the four vertices of the tetrahedron cell. The constituent cell types may be either primary cell types or hybrid cell types according to some embodiments.

FIG. 23 illustrates a 3D object containing regions with five different primary lattice unit cells in different zones, all zones transitioning to adjacent zones through intermediate regions. The transition cells blend the assigned cell types together to create a continuous lattice structure according to some embodiments.

FIGS. 24-25 illustrate a latticed helmet pad with different lattice structures on the outer and inner surfaces. The outer surfaces are tetrahedral cell types and the inner surfaces are Voronoi cell types according to some embodiments.

FIG. 26 illustrates two lattice zones including a heart-shaped region and a spherical region (left), which are used to assign cell types to create the lattice dog or pub shaped figure (right) according to some embodiments.

FIG. 27 illustrates three cell types that are assigned to four points indicated by circles according to some embodiments.

FIG. 28 illustrates equations that may be used to generate a continuous, spatially varying cell field and a corresponding heatmap visualization.

FIG. 29 illustrates the lattice structure corresponding to the cell field of FIG. 28 with Voronoi cells in the center of the puck that gradually transition into icosahedral cells along the boarder according to some embodiments.

FIG. 30 illustrates a volume fraction (left) and simulated effective Young's modulus for an EPU40 lattice puck composed of tetrahedral-icosahedral hybrid cells with the percentage of tetrahedral cells plotted along the x-axis according to some embodiments.

FIG. 31 illustrates large deformation simulations of EPU40 pucks composed of icosahedral-tetrahedral hybrid cells. Preliminary result indicate that the 80% tetrahedral/20$icosahedral cell has good agreement between a simulation and experimental results.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may otherwise be oriented (rotated 90 degrees or at other orientations) and the spatially relative descriptors used herein interpreted accordingly. Similarly, the terms “upwardly.” “downwardly.” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

“Truncated octahedron” refers to a unit cell having 36 struts (or “edges”) interconnected at 24 nodes (or “vertices”) configured to define 8 regular hexagon faces and 6 square faces. It has both tetrahedral symmetry and cubic symmetry (and can therefore populate both tetrahedral and hexahedral meshes). The primary unit cell informally named a “Kelvin” cell herein is a truncated octahedron unit cell.

### A. Identification of Problem

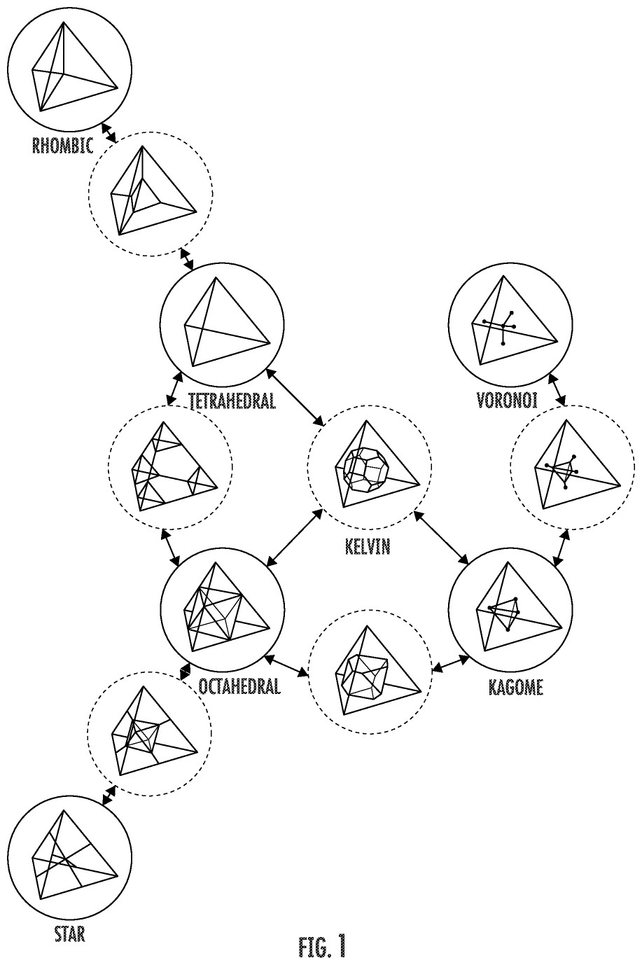

A map of transition pathways between a set of primary lattice unit cells was generated. This map is set forth in FIG. 1. Primary lattice unit cells (informally named Rhombic, Tetrahedron (Tetra), Octahedral, Star, Kagome, and Voronoi (Voro), all in solid circles) through intermediate unit cells (dashed circles, one, a truncated octahedron, informally named “Kelvin” for later reference).

As shown in FIG. 1, some primary unit cells can directly transition to three other primary unit cells through a single intermediate cell (for example, Octahedral can transition directly to any of Star, Tetrahedral, or Kagome; Kagome can transition to any of Voronoi, Tetrahedral, or Octahedral; etc.). while other primary unit cells can directly transition to only a single other primary unit cell (Rhombic to Tetrahedral, and Star to Octahedral). This is a problem when the design of a lattice product requires two (or more) regions near one another having properties (e.g., mechanical or tensile properties) best obtained with distinct, specific primary unit cells, but those cells have no direct path for transitioning to one another, or require indirectly transitioning through still another primary lattice unit cell that has unsatisfactory or less preferable properties for that product.

### B. Methods And Systems

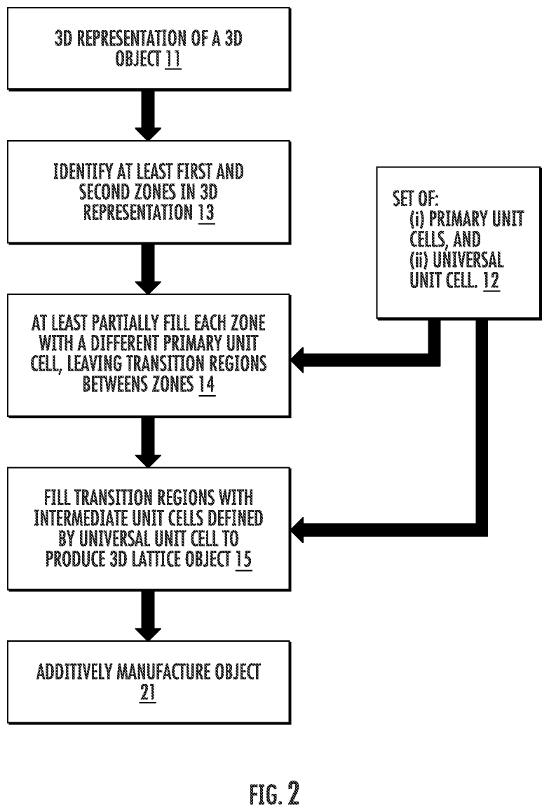

A computer-implemented method of making a three-dimensional (3D) lattice object is described herein. The lattice object (a variety of examples of which are given below) includes multiple zones of different lattice unit cells that smoothly transition between zones. As schematically illustrated in FIG. 2 and further in FIGS. 8A), the method includes the steps of: (a) providing (12) a set of at least two, three, four, five, six, or seven (or more) primary unit cells and one universal unit cell, (i) each primary and universal unit cell comprising a set of struts interconnected at nodes, (ii) each primary unit cell in said set configured to smoothly transition to every other primary unit cell in the set through a series of intermediate unit cells, (iii) and with all of the primary and intermediate unit cells defined by the universal unit cell; (b) providing (11) a 3D representation of the 3D object (for example, as a polyhedral mesh, such as a tetrahedral or hexahedral mesh); (c) identifying (13) at least a first and second zone (A and B) in the 3D representation; (d) at least partially filling (14) the first zone with interconnected units of one of the primary or intermediate unit cells, and at least partially filling the second zone with interconnected units of a different one of the primary or intermediate unit cells, while leaving a first transition region (AB) between the zones; and (e) filling the first transition region (15) with a progressive series of intermediate unit cells, the struts of the intermediate cells in the progressive series gradually increasing or decreasing in length: (i) as they approach the (primary or intermediate) unit cell contained in each respective zone, and (ii) in conformance with the (primary or intermediate) unit cell contained in each respective zone, to thereby create a 3D lattice object comprising multiple zones of different unit cells that smoothly transition between zones. At this point, the 3D lattice object comprises a data structure, typically in the form of a filled polyhedral (e.g., tetrahedral or hexahedral) mesh. In some embodiments, the method may further include the step of additively manufacturing (21) the object.

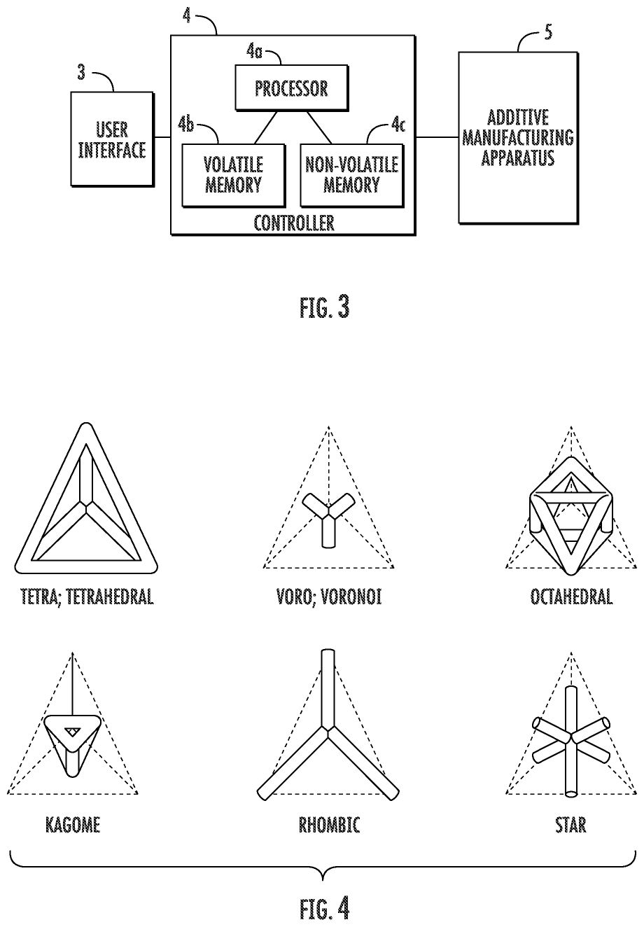

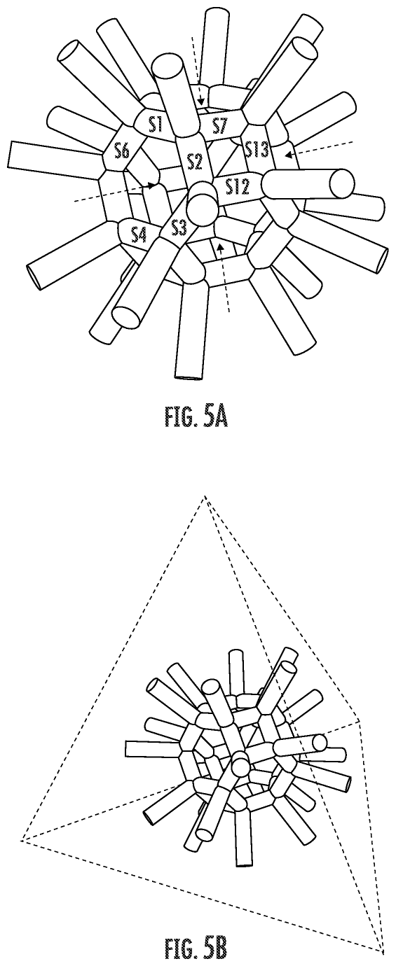

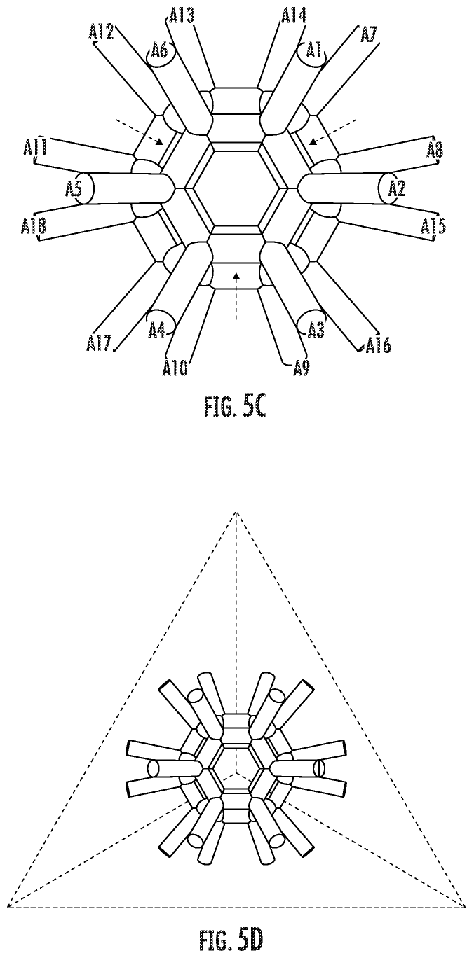

The universal unit cell defines all of the primary and intermediate unit cells by (i) allowing struts in the universal unit cell to decrease in length to zero (e.g., during the filling step (e)), and (ii) allowing multiple struts in the universal unit cell to collapse directly into one another and form a single strut (e.g., during the filling step (e)). FIG. 4 illustrates a group of six lattice cells that can be used (along with a truncated octahedron or “Kelvin” cell) as primary unit cells in the processes, lattices, and apparatus described herein. Note names of cells are arbitrary or suggestive, rather than formal. FIGS. 5A-5D illustrate a universal unit cell that can be used with the primary unit cells noted in connection with FIG. 4 above. This universal cell consists of (i) a truncated octahedron (as defined above) core having 36 struts interconnected at 24 nodes, and (ii) 24 arms, each node having an arm connected to and extending outward therefrom. A subset of struts are numbered S1, S2, S3, S4, S5, S6, S7, S12, and S13 in FIG. 5A; and a subset of arms are numbered A1 to A18 in FIG. 5C.

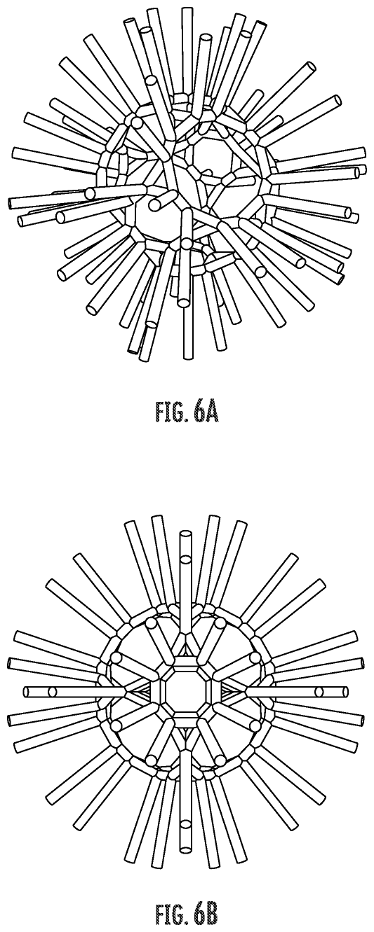

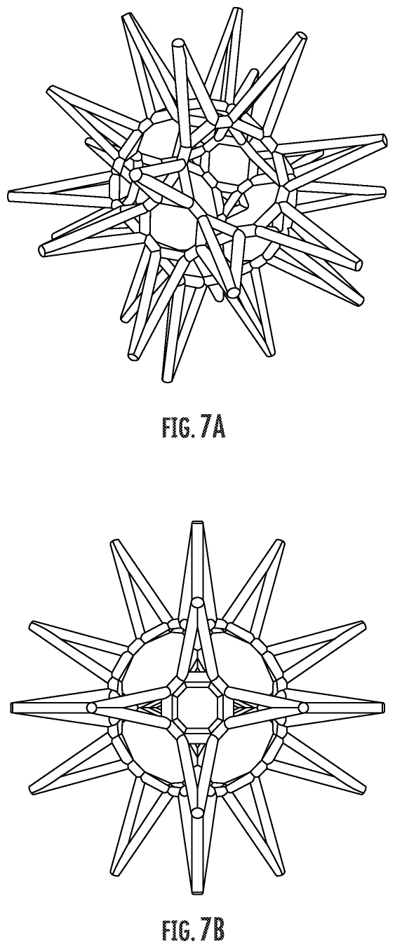

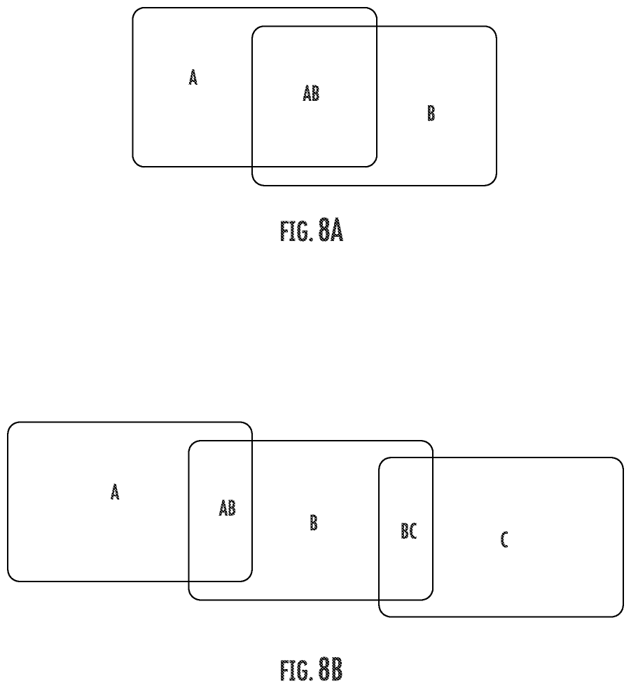

The universal unit cell of FIGS. 5A-5D is, however, a non-limiting example, as numerous alternative universal unit cells can be readily identified. For example, a first alternative universal unit cell is given in FIGS. 6A-6B, and a second alternative universal unit cell is given in FIGS. 7A-7B. In general, more complex alternative universal lattice cells can be derived from simpler universal lattice cells using methods such as, but not limited to, splitting nodes into a ring or ball of connected nodes/struts, splitting a strut into multiple struts, and the addition of additional strut branches. More complex universal lattice cells enable representing a richer variety of cell types while remaining backwards compatible with existing cell types representable by simpler universal lattice cells.

In some embodiments (schematically illustrated by FIG. 8B): step (c) includes identifying at least a first, second, and third zone (A, B, and C) in the 3D representation; step (d) further includes filling the third zone with interconnected units of one of the primary or intermediate unit cells different from the interconnected units that at least partially fill the first and second zones, while leaving a second transition region (AB) between the second zone and the third zone, and step (e) further includes filling the second transition region with the progressive series of intermediate unit cells.

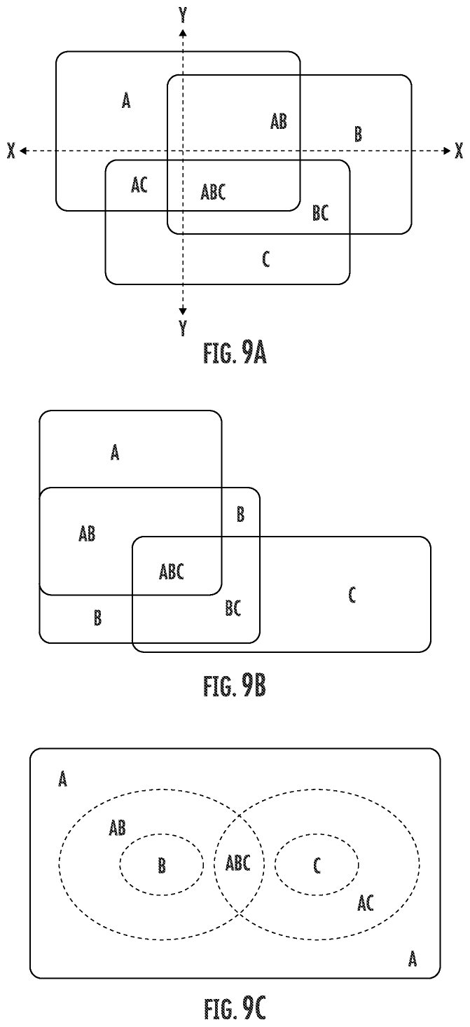

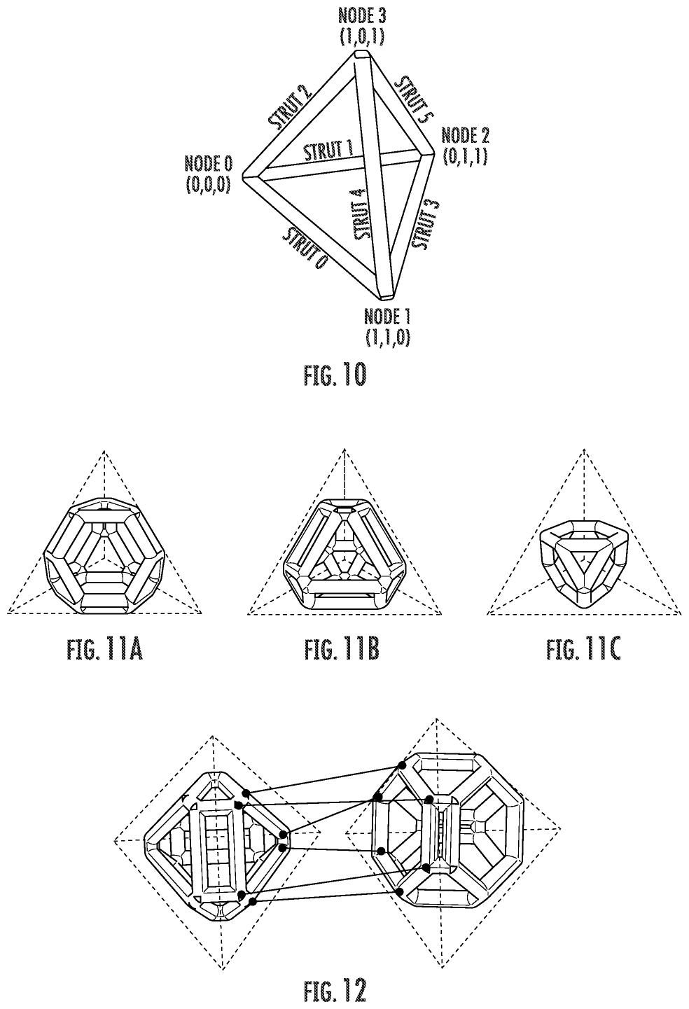

In some embodiments (schematically illustrated in FIGS. 9A-9C), step (d) further includes leaving a third transition region (ABC) between all of the first zone, the second zone, and the third zone, and step (e) further includes filling the third transition region with the progressive series of intermediate unit cells. In some embodiments, the progressive series of intermediate unit cells in the third transition region varies along at least two distinct vectors or dimensions (for example, as represented by dashed lines x-x and y-y in FIG. 9A).

In some embodiments, the step of identifying at least a first and second zone, and the third zone if present, is carried out by: (i) specifying at least one boundary in the 3D representation that defines each zone; (ii) specifying at least one point in the 3D representation that defines each zone; or (iii) a combination thereof.

As noted above, in some embodiments the filled polyhedral mesh of the 3D object may be represented as a data structure. The data structure may be translated to one or more instruction files in a format that can be provided to an additive manufacturing apparatus to produce the 3D object in step 21 (FIG. 2). For example, the filled polyhedral mesh may be represented by an instruction file in an STL file format. Numerous alternatives to STL files can be used, including but not limited to PLY, OBJ, 3MF, AMF, VRML, X3G, and FBX files, and others as set forth in Barnes et al., US Patent Application Pub. No. 20190026406 (Jan. 24, 2019) and Mummidi et al., US Patent Application Pub. No. 20180113437 (Apr. 26, 2018). The instruction file may include one or more data and/or instructions sets that, when interpreted by an additive manufacturing apparatus or a processor associated therewith, cause the additive manufacturing apparatus to control the physical elements of the additive manufacturing apparatus to manufacture the 3D object.

As schematically illustrated in FIG. 3 and discussed further below, there is also provided a computer program product for operating an electronic device comprising a non-transitory computer readable storage medium having computer readable program code embodied in the medium that, when executed by a processor, causes the processor to perform operations comprising the methods described above and further described below.

### C. Apparatus\

An apparatus for carrying out a non-limiting embodiment of the present invention is schematically illustrated in FIG. 3. Such an apparatus includes a user interface 3 for inputting instructions (such as selection of an object to be produced, and selection of features to be added to the object), a controller 4, and in some embodiments an additive manufacturing apparatus 5 such as described below. An optional washer (not shown) can be included in the system if desired, or a separate washer can be utilized. Similarly, for dual cure resins, an oven (not shown) can be included in the system, although a separately-operated oven can also be utilized.

Connections between components of the system can be by any suitable configuration, including wired and/or wireless connections. The components may also communicate over one or more networks, including any conventional, public and/or private, real and/or virtual, wired and/or wireless network, including the Internet.

The controller 4 may be of any suitable type, such as a general-purpose computer. Typically, the controller will include at least one processor 4a, a volatile (or “working”) memory 4b, such as random-access memory, and at least one non-volatile or persistent memory 4c, such as a hard drive or a flash drive. The controller 4 may use hardware, software implemented with hardware, firmware, tangible computer-readable storage media having instructions stored thereon, and/or a combination thereof, and may be implemented in one or more computer systems or other processing systems. The controller 4 may also utilize a virtual instance of a computer. As such, the devices and methods described herein may be embodied in any combination of hardware and software that may all generally be referred to herein as a “circuit,” “module,” “component,” and/or “system.” Furthermore, example embodiments of the present inventive concepts may take the form of a computer program product comprising a non-transitory computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one processor 4a of the controller 4 may be configured to execute computer program code for carrying out operations for aspects of the present invention, which computer program code may be written in any combination of one or more programming languages, including an object oriented programming language such as Java, Scala, Smalltalk, Eiffel, JADE, Emerald, C++, C#, VB.NET, or the like, conventional procedural programming languages, such as the “C” programming language, Visual Basic, Fortran 2003, COBOL 2002, PHP, ABAP, dynamic programming languages such as Python, PERL, Ruby, and Groovy, or other programming languages.

The at least one processor 4a may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices, which may be collocated or distributed across one or more data networks.

Connections between internal components of the controller 4 are shown only in part and connections between internal components of the controller 4 and external components are not shown for clarity, but are provided by additional components known in the art, such as busses, input/output boards, communication adapters, network adapters, etc. The connections between the internal components of the controller 4, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, an Advanced Technology Attachment (ATA) bus, a Serial ATA (SATA) bus, and/or an Institute of Electrical and Electronics Engineers (IEEE) standard 1394 bus, also called “Firewire.”

The user interface 3 may be of any suitable type. The user interface 3 may include a display and/or one or more user input devices. The display may be accessible to the at least one processor 4a via the connections between the system components. The display may provide graphical user interfaces for receiving input, displaying intermediate operation/data, and/or exporting output of the methods described herein. The display may include, but is not limited to, a monitor, a touch screen device, etc., including combinations thereof. The input device may include, but is not limited to, a mouse, keyboard, camera, etc., including combinations thereof. The input device may be accessible to the at least one processor 4a via the connections between the system components. The user interface 3 may interface with and/or be operated by computer readable software code instructions resident in the volatile memory 4b that are executed by the processor 4a.

Example embodiments of the present inventive concepts are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor (e.g., processor 4a) of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

### D. Example

### 1 Preliminaries

### 1.1 Lattice Structure Representation

Lattice structures, consisting of nodes (defined by 3D points in space) and struts (defined by two nodes to represent endpoints), can be represented using an undirected graph G(V, E) where V are the set of nodes and E are the set of edges. V can be represented by an N×3 matrix where N is the total number of nodes in the lattice structure and each row represents a node's 3D position in space. E can be represented by an M×2 matrix where M is the total number of struts in the lattice structure and each row contains two indices into matrix V, corresponding to two endpoint nodes. For example, the lattice structure shown in FIG. 10, consisting of four nodes and six struts, can be represented by the following matrices:

$$V = [ \begin{matrix}0 & 0 & 0 \\ 1 & 1 & 0 \\ 0 & 1 & 1 \\ 1 & 0 & 1\end{matrix} ]$$

$$E = [ \begin{matrix}0 & 1 \\ 0 & 2 \\ 0 & 3 \\ 1 & 2 \\ 1 & 3 \\ 2 & 3\end{matrix} ]$$

The order in which rows appear in E does not matter. Likewise, the order in which rows appear in V also does not matter as long as the indices in E are updated accordingly.

### 1.2 Barycentric Coordinates

The position of nodes may be represented using barycentric coordinates (u, v, w) relative to a reference tetrahedron T. A reference tetrahedron T is defined by four points in 3D space—its points should be defined relative to some inertial frame in Cartesian coordinates. T can be presented by a 4×3 matrix. For example, the following matrix defines a tetrahedron with points located at (x₀, y₀, z₀), (x₁, y₁, z₁), (x₂, y₂, z₂), and (x₃, y₃, z₃):

$$T = [ \begin{matrix}{x}_{0} & {y}_{0} & {z}_{0} \\ {x}_{1} & {y}_{1} & {z}_{1} \\ {x}_{2} & {y}_{2} & {z}_{2} \\ {x}_{3} & {y}_{3} & {z}_{3}\end{matrix} ]$$

Barycentric coordinates (u, v, w) relative to tetrahedron T can be readily converted to and from Cartesian coordinates (x, y, z) in the inertial frame using the following relations:

$$x = {ux}_{0} + {vx}_{2} + {wx}_{3} + ( 1 - u - v - w ) {x}_{3}$$

$$y = {uy}_{0} + {vy}_{1} + {wy}_{2} + ( 1 - u - v - w ) {y}_{3}$$

$$z = {uz}_{0} + {vz}_{1} + {wz}_{2} + ( 1 - u - v - w ) {z}_{3}$$

There is no loss of information during the conversion, so either Cartesian coordinates or barycentric coordinates may be used. However, barycentric coordinates will be used for convenience (for reasons to be evident in later sections). One interpretation of barycentric coordinates is that they are relative coordinates—relative in the sense that they refer back to some reference tetrahedron. By changing the reference tetrahedron but still keeping the barycentric coordinates the same, the converted Cartesian coordinates in the inertial frame will change.

### 2 Unit Cells

Unit cells are lattice structures contained completely inside a reference tetrahedron. The nodes V can be represented using barycentric coordinates. There are infinitely many unit cells that can be defined, but some finite set may be chosen as primary unit cells for constructing large scale lattice structures. This finite set of primary unit cells may be chosen arbitrarily, but deciding factors may include aesthetics and mechanical properties. Several examples of primary unit cells are shown in FIG. 4 and their definitions are given below:

| Primary Unit Cell | V | E |
|---|---|---|
| TETRAHEDRAL | $[ \begin{matrix}0 & 0 & 0 \\ 1 & 1 & 0 \\ 0 & 1 & 1 \\ 1 & 0 & 1\end{matrix} ]$ | $[ \begin{matrix}0 & 1 \\ 0 & 2 \\ 0 & 3 \\ 1 & 2 \\ 1 & 3 \\ 2 & 3\end{matrix} ]$ |
| OCTAHEDRAL | $[ \begin{matrix}0 & 0 & 0.5 \\ 0 & 0.5 & 0 \\ 0 & 0.5 & 0.5 \\ 0.5 & 0 & 0 \\ 0.5 & 0 & 0.5 \\ 0.5 & 0.5 & 0\end{matrix} ]$ | $[ \begin{matrix}0 & 1 \\ 0 & 2 \\ 0 & 3 \\ 0 & 4 \\ 1 & 2 \\ 1 & 3 \\ 1 & 5 \\ 2 & 4 \\ 2 & 5 \\ 3 & 4 \\ 3 & 5 \\ 4 & 5\end{matrix} ]$ |
| KAGOME | $[ \begin{matrix}0 & 0.33 & 0.33 \\ 0.33 & 0 & 0.33 \\ 0.33 & 0.33 & 0 \\ 0.33 & 0.33 & 0.33\end{matrix} ]$ | $[ \begin{matrix}0 & 1 \\ 0 & 2 \\ 0 & 3 \\ 1 & 2 \\ 1 & 3 \\ 2 & 3\end{matrix} ]$ |

### 2.1 Universal Unit Cell

The example unit cells in the previous section (TETRAHEDRAL, OCTAHEDRAL, and KAGOME) may have different numbers of nodes and struts—specifically, their definitions of V and E may not all have the same matrix size. In an effort to generalize the three seemingly different unit cells, a universal unit cell representation is constructed. The universal unit cell representation is defined by parameterizing each of the three unit cells with a single definition of E (called Eᵤₙᵢᵥₑᵣₛₐₗ) and a single matrix size for V. Physically, this can be interpreted as redefining the three unit cells using the same number of nodes and the same strut connectivity for each unit cell. No additional nodes may be added and existing nodes may not be deleted; likewise, no additional struts may be added and existing struts may not be deleted. However, the position of the nodes for each unit cell type may be changed. In addition, multiple nodes may share the same position, effectively allowing zero-length struts to be created. The three example unit cells above are now parameterized in this universal representation using 24 nodes and one single definition of Eᵤₙᵢᵥₑᵣₛₐₗ containing 36 struts as follows:

| Primary Cell Type | V | E |
|---|---|---|
| TETRAHEDRAL | $[ \begin{matrix}0 & 1 & 0 \\ 0 & 1 & 0 \\ 0 & 0 & 0 \\ 0 & 0 & 0 \\ 0 & 1 & 0 \\ 0 & 1 & 0 \\ 0 & 0 & 0 \\ 0 & 0 & 0 \\ 1 & 0 & 0 \\ 0 & 1 & 0 \\ 0 & 1 & 0 \\ 0 & 0 & 1 \\ 0 & 0 & 1 \\ 0 & 0 & 0 \\ 0 & 0 & 0 \\ 1 & 0 & 0 \\ 1 & 0 & 0 \\ 0 & 0 & 1 \\ 0 & 0 & 1 \\ 1 & 0 & 0 \\ 1 & 0 & 0 \\ 0 & 0 & 1 \\ 0 & 0 & 1 \\ 1 & 0 & 0\end{matrix} ]$ | $[ \begin{matrix}0 & 1 \\ 1 & 2 \\ 2 & 3 \\ 0 & 3 \\ 0 & 4 \\ 1 & 5 \\ 2 & 6 \\ 3 & 7 \\ 4 & 8 \\ 4 & 9 \\ 5 & 10 \\ 5 & 11 \\ 6 & 12 \\ 6 & 13 \\ 7 & 14 \\ 7 & 15 \\ 8 & 16 \\ 9 & 16 \\ 9 & 10 \\ 10 & 17 \\ 11 & 17 \\ 11 & 12 \\ 12 & 18 \\ 13 & 18 \\ 13 & 14 \\ 14 & 19 \\ 15 & 19 \\ 8 & 15 \\ 16 & 20 \\ 17 & 21 \\ 18 & 22 \\ 19 & 23 \\ 20 & 21 \\ 21 & 22 \\ 22 & 23 \\ 23 & 20\end{matrix} ]$ |
| OCTAHEDRAL | $[ \begin{matrix}0 & 0.5 & 0 \\ 0 & 0.5 & 0 \\ 0 & 0.5 & 0 \\ 0 & 0.5 & 0 \\ 0.5 & 0.5 & 0 \\ 0 & 0.5 & 0.5 \\ 0 & 0 & 0.5 \\ 0.5 & 0 & 0 \\ 0.5 & 0.5 & 0 \\ 0.5 & 0.5 & 0 \\ 0 & 0.5 & 0.5 \\ 0 & 0.5 & 0.5 \\ 0 & 0 & 0.5 \\ 0 & 0 & 0.5 \\ 0.5 & 0 & 0 \\ 0.5 & 0 & 0 \\ 0.5 & 0.5 & 0 \\ 0 & 0.5 & 0.5 \\ 0 & 0 & 0.5 \\ 0.5 & 0 & 0 \\ 0.5 & 0 & 0.5 \\ 0.5 & 0 & 0.5 \\ 0.5 & 0 & 0.5 \\ 0.5 & 0 & 0.5\end{matrix} ]$ | |
| KAGOME | $[ \begin{matrix}0.33 & 0.33 & 0 \\ 0 & 0.33 & 0.33 \\ 0 & 0.33 & 0.33 \\ 0.33 & 0.33 & 0 \\ 0.33 & 0.33 & 0 \\ 0 & 0.33 & 0.33 \\ 0 & 0.33 & 0.33 \\ 0.33 & 0.33 & 0 \\ 0.33 & 0.33 & 0 \\ 0.33 & 0.33 & 0.33 \\ 0.33 & 0.33 & 0.33 \\ 0 & 0.33 & 0.33 \\ 0 & 0.33 & 0.33 \\ 0.33 & 0 & 0.33 \\ 0.33 & 0 & 0.33 \\ 0.33 & 0.33 & 0 \\ 0.33 & 0.33 & 0.33 \\ 0.33 & 0.33 & 0.33 \\ 0.33 & 0 & 0.33 \\ 0.33 & 0 & 0.33 \\ 0.33 & 0.33 & 0.33 \\ 0.33 & 0.33 & 0.33 \\ 0.33 & 0 & 0.33 \\ 0.33 & 0 & 0.33\end{matrix} ]$ | |

Note that the universal parameterization is not unique. It simply needs to be able to represent all chosen unit cells of interest using a single definition of E (called Eᵤₙᵢᵥₑᵣₛₐₗ) and a single matrix size for V (in the example above, V is a 24×3 matrix for every unit cell). If additional unit cells of interest are added, the definition of Eᵤₙᵢᵥₑᵣₛₐₗ and matrix size for V may need to change to be able to represent the newly added unit cell as well as any existing unit cells of interest.

### 2.2 Intermediate Unit Cells

Using the universal unit cell representation described above, intermediate unit cells can be defined as some convex combination of two or more primary unit cell types. Every intermediate unit cell can be represented by the graph G_{intermediate}(V_{intermediate}, Eᵤₙᵢᵥₑᵣₛₐₗ) where

$${V}_{intermediate} = {\sum }_{i}^{P} {w}_{i} {V}_{i}$$

$$0 \leq {w}_{i \leq 1}$$

$${\sum }_{i}^{P} {w}_{i} = 1$$

The variable wᵢ can be interpreted as the fractional weight of the i-th unit cell type. The value of every weight must be between 0 and 1 and the sum of all of the weights for every unit cell type must equal 1. The set of weights that specify a particular intermediate unit cell can succinctly be written in the form of a weight vector, containing a list of primary unit cell names paired with decimal weight values. For example, the intermediate unit cell composed of 25% TETRAHEDRAL, 50% OCTAHEDRAL, and 25% KAGOME can be computed from V_{intermediate}=0.25V_{TETRAHEDRAL}+0.50V_{OCTAHEDRAL}+0.25V_{KAGOME}. Its weight vector can be written as (w_{TETRAHEDRAL}:0.25, w_{OCTAHEDRAL}:0.5w_{KAGOME}:0.25). A sample of intermediate cells along with their defining weight vectors is shown in FIGS. 11A-11C.

### 3 Transition Lattice Generation

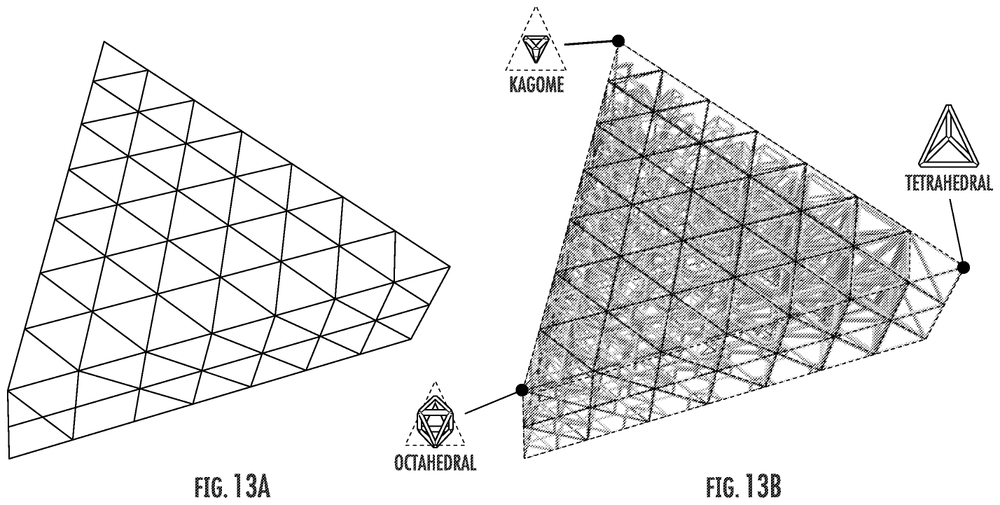

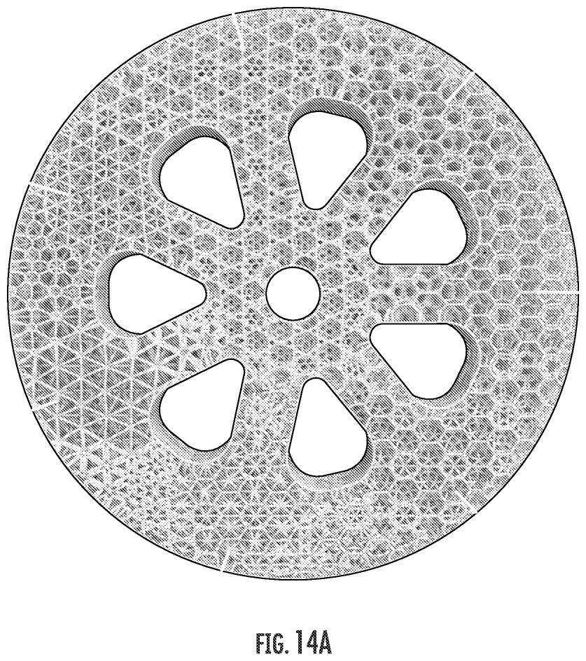

To generate a lattice structure composed of multiple unit cells and intermediate cells in a region of interest, first a tetrahedron mesh of the region of interest is generated in accordance with known techniques, such as set forth in Si, H. TetGen, a Delaunay-based quality tetrahedral mesh generator. ACM Transactions on Mathematical Software (TOMS), 41(2), 1-36 (2015); Kabaria, H., & Lew, A. J. Universal meshes for smooth surfaces with no boundary in three dimensions. International Journal for Numerical Methods in Engineering, 110(2), 133-162 (2017); or Hu, Y., Schneider, T., Wang, B., Zorin, D., & Panozzo, D. (2020). Fast tetrahedral meshing in the wild. ACM Transactions on Graphics (TOG), 39(4), 117-1 (2020). Each tetrahedron in the mesh is then assigned a weight vector such as (w_{TETRAHEDRAL}: 0.25, w_{OCTAHEDRAL}: 0.5, w_{KAGOME}:0.25). The weight vector for each tetrahedron may be assigned arbitrarily and may depend on factors such as, but not limited to, particular desired aesthetic or mechanical properties in a particular region of the design space. A lattice cell for each tetrahedron is then generated by first computing V_{intermediate} for the cell using the weight vector, then converting all of the barycentric coordinates in V_{intermediate} to Cartesian coordinates in the inertial frame. To facilitate that struts between tetrahedrons connect together, the Cartesian coordinates of matching nodes on the boundaries of adjacent tetrahedrons are averaged together, as depicted in FIG. 12. An example of a transition lattice structure generated inside a triangular region of interest using this approach is depicted in FIGS. 13A-13B.

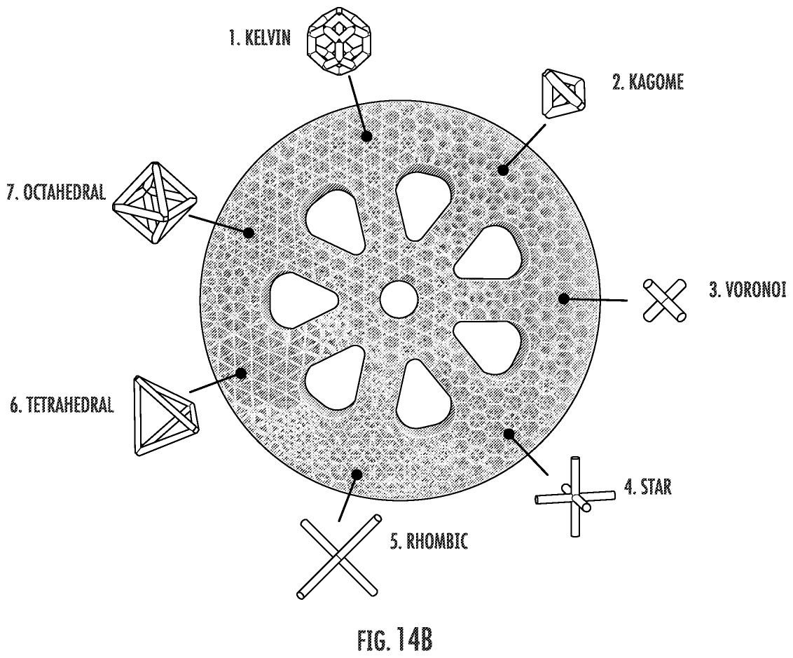

While this example only depicts the transition between three primary unit cells (TETRAHEDRAL, OCTAHEDRAL, and KAGOME), additional primary unit cells may be introduced and represented using an appropriate universal unit cell representation. FIGS. 14A-B depicts seven primary unit cells and their intermediate cells in a wheel-shaped region of interest.

### E. Addditive Manufacturing

Techniques for additive manufacturing are known. Suitable techniques include, but are not limited to, techniques such as selective laser sintering (SLS), fused deposition modeling (FDM), stereolithography (SLA), material jetting including three-dimensional printing (3DP) and multij et modeling (MJM)(MJM including Multi-Jet Fusion such as available from Hewlett Packard), and others. See, e.g., H. Bikas et al., Additive manufacturing methods and modelling approaches: a critical review, Int. J. Adv. Manuf Technol. 83, 389-405 (2016).

Resins for additive manufacturing of polymer articles are known and described in, for example, DeSimone et al., U.S. Pat. Nos. 9,211,678; 9,205,601; and 9,216,546. Dual cure resins for additive manufacturing are known and described in, for example, Rolland et al., U.S. Pat. Nos. 9,676,963; 9,598,606; and 9,453,142. Non-limiting examples of dual cure resins include, but are not limited to, resins for producing objects comprised of polymers such as polyurethane, polyurea, and copolymers thereof; objects comprised of epoxy; objects comprised of cyanate ester; objects comprised of silicone, etc.

Stereolithography, including bottom-up and top-down techniques, are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of these patents and applications are incorporated by reference herein in their entirety.

In some embodiments, the object is formed by continuous liquid interface production (CLIP). CLIP is known and described in, for example, PCT Application Nos. PCT/US2014/015486 (U.S. Pat. No. 9,211,678); PCT/US2014/015506 (U.S. Pat. No. 9,205,601), PCT/US2014/015497 (U.S. Pat. No. 9,216,546), and in J. Tumbleston, D. Shirvanyants, N. Ermoshkin et al., Continuous liquid interface production of 3D Objects, Science 347, 1349-1352 (2015). See also R. Janusziewcz et al., Layerless fabrication with continuous liquid interface production, Proc. Natl. Acad. Sci. USA 113, 11703-11708 (Oct. 18, 2016). In some embodiments, CLIP employs features of a bottom-up three-dimensional fabrication as described above, but the irradiating and/or said advancing steps are carried out while also concurrently maintaining a stable or persistent liquid interface between the growing object and the build surface or window, such as by: (i) continuously maintaining a dead zone of polymerizable liquid in contact with said build surface, and (ii) continuously maintaining a gradient of polymerization zone (such as an active surface) between the dead zone and the solid polymer and in contact with each thereof, the gradient of polymerization zone comprising the first component in partially-cured form. In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I. Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

Other examples of methods and apparatus for carrying out particular embodiments of CLIP include, but are not limited to: Batchelder et al., Continuous liquid interface production system with viscosity pump, US Patent Application Pub. No. US 2017/0129169 (May 11, 2017); Sun and Lichkus, Three-dimensional fabricating system for rapidly producing objects, US Patent Application Pub. No. US 2016/0288376 (Oct. 6, 2016); Willis et al., 3d print adhesion reduction during cure process, US Patent Application Pub. No. US 2015/0360419 (Dec. 17, 2015); Lin et al., Intelligent 3d printing through optimization of 3d print parameters, US Patent Application Pub. No. US 2015/0331402 (Nov. 19, 2015); and D. Castanon, Stereolithography System, US Patent Application Pub. No. US 2017/0129167 (May 11, 2017).

After the object is formed, it is typically cleaned (e.g., by washing, centrifugal separation, etc.), and in some embodiments then further cured, preferably by baking (although further curing may in some embodiments be concurrent with the first cure, or may be by different mechanisms such as contacting to water, as described in U.S. Pat. No. 9,453,142 to Rolland et al.).

### F. Three-Dimensional (3D) Objects

Additively manufactured 3D objects as described herein can be produced by any of the processes and systems described above. Depending on the process chosen, the object may be formed of a polymer (including polymer blends), metal, ceramic, or composite thereof. Where a dual cure resin is used as the build material in the additive manufacturing process, the object may be comprised of, consists of, or consists essentially of the reaction products of a dual cure polymer resin. In some embodiments, the object and/or lattice may be rigid, flexible, or elastic, depending on the material from which the object is produced, and/or the geometric design of the object itself.

A variety of different types of objects can be produced by the processes and methods described herein. In some embodiments, the object may be or include a cushion (e.g., a body pad such as a helmet liner, a seat cushion, saddle, headrest, etc.) or a shock absorber (e.g., an automotive or aerospace body panel or body panel insert, etc.). In some embodiments, the object is In some embodiments, the object comprises or includes a brace, arm, link, shock absorber, cushion or pad (e.g., a bed or seat cushion; a wearable protective device such as a shin guard, knee pad, elbow pad, sports brassiere, bicycling shorts, backpack strap, backpack back pad (i.e., that pad or portion that rests against the wearer's back), neck brace, chest protector, protective vest, protective jacket, slacks, etc., including an insert therefor; an automotive or aerospace panel, bumper, or component; etc.). In some embodiments, the object comprises a footwear insole, midsole, or orthotic insert, a bicycle saddle, or a helmet liner. Note also that, in some embodiments, the lattice of the object may include a conformal lattice.

Some embodiments of the foregoing are schematically exemplified by FIGS. 9A, 9B, and 9c above. In these embodiments, the product includes:
(a) a first zone (A) comprising, consisting of, or consisting essentially of interconnected units of a first lattice unit cell;
(b) a second zone (B) comprising, consisting of, or consisting essentially of interconnected units of a second lattice unit cell;
(c) a third zone (C) comprising, consisting of, or consisting essentially of interconnected units of a third lattice unit cell;
(d) a first transition region (AB) between the first and second zone comprising, consisting of, or consisting essentially of intermediate lattice unit cells smoothly transitioning between both the zones;
(e) a second transition (BC) region between the second and third zone comprising, consisting of, or consisting essentially of intermediate lattice unit cells smoothly transitioning between both the zones; and
(f) a third transition region (ABC) between the first, second, and third zones comprising intermediate lattice unit cells smoothly transitioning between all of the zones.

All unit cells in the foregoing (first lattice unit cell, second lattice unit cell, third lattice unit cell, and smoothly transitioning intermediate lattice unit cells in the first, second, and third transition regions) may be defined or definable by a single universal unit cell as noted above. Additional zones and transition regions can be included as needed for the particular object made.

As an additional example, FIGS. 14A-14B show a seven spoked wheel 3D object containing regions with seven different primary lattice unit cells in different zones. All zones transition to adjacent zones through intermediate regions filled with intermediate unit cells. Note that adjacent zones containing Rhombic and Star unit cells smoothly and directly transition from one to the other, and adjacent zones containing Star and Voronoi unit cells smoothly and directly transition to one another, even though no direct path for such transition is available in FIG. 1.

### G. Intracellular Transitions

Methods of facilitating connectivity of struts at cell boundaries in the tetrahedron mesh include creating a C° continuous cell field. This is done by assigning a cell type (primary or a weighted mixture) at every vertex in the tetrahedron mesh. The lattice structure within each tetrahedron mesh cell is then created by satisfying a self-consistency condition given by

$${b}_{i} = {B}_{i} {A}_{j} {b}_{i}$$

where bᵢ is the barycentric coordinate of the i-th node of the lattice structure, Bᵢ is an interpolation matrix for the i-th node that converts a weighted cell type to a barycentric coordinate, and Aⱼ is an additional interpolation matrix for the j-th cell in the tetrahedron mesh that converts a barycentric coordinate into a weighted cell type. The structure and values of of Bᵢ are determined by the primary cell types, whereas the structure and values of Aⱼ are determined by the cell type assignments applied to the vertices of the tetrahedron mesh cell.

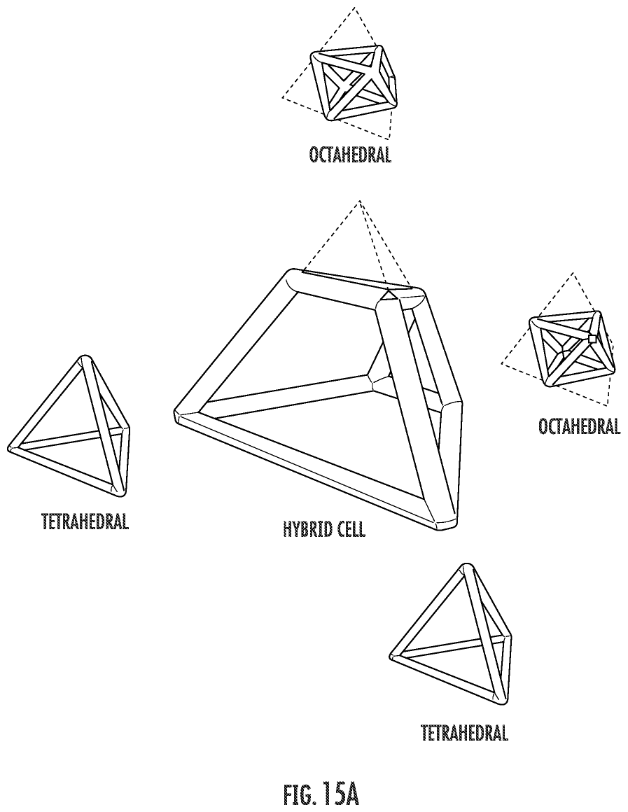

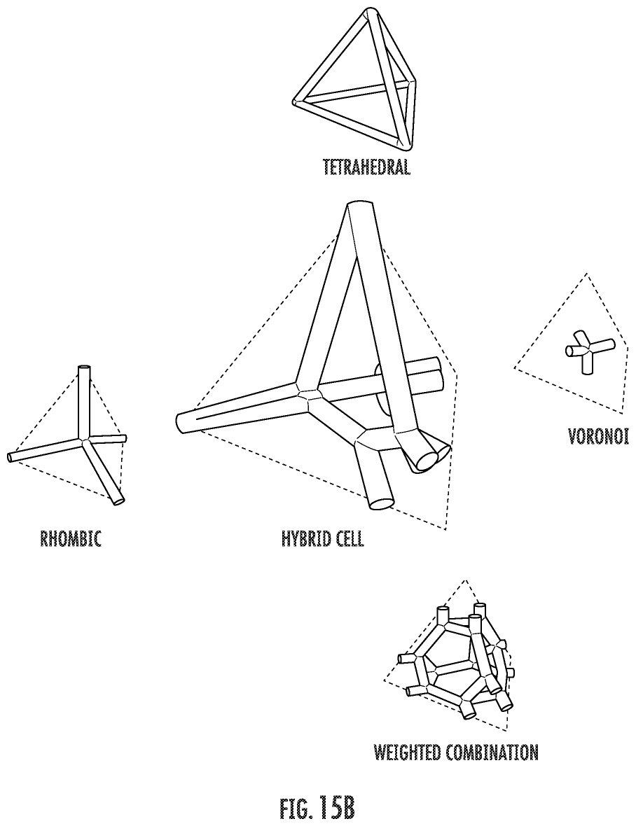

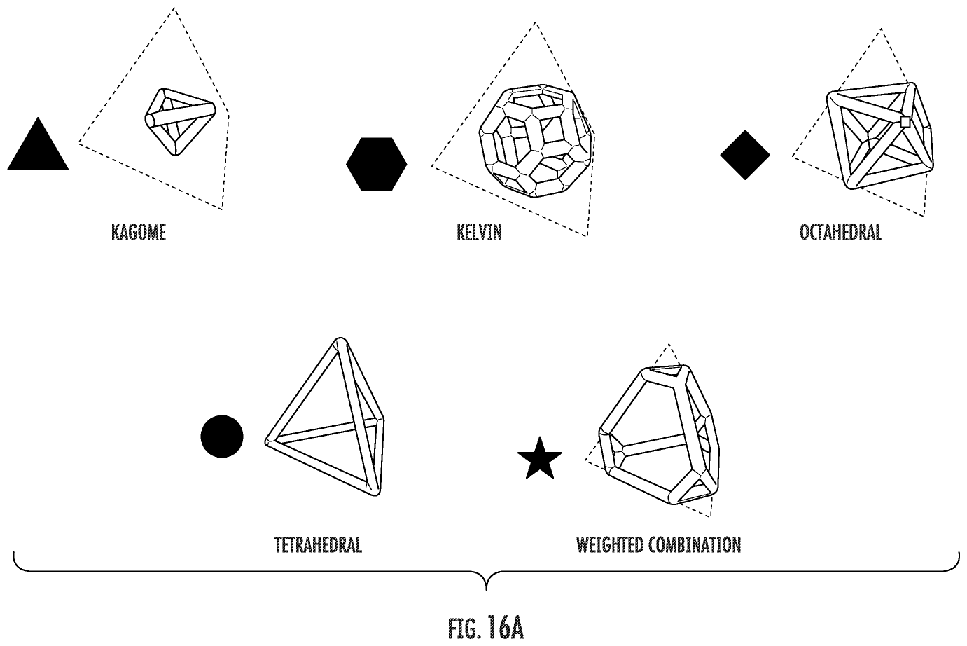

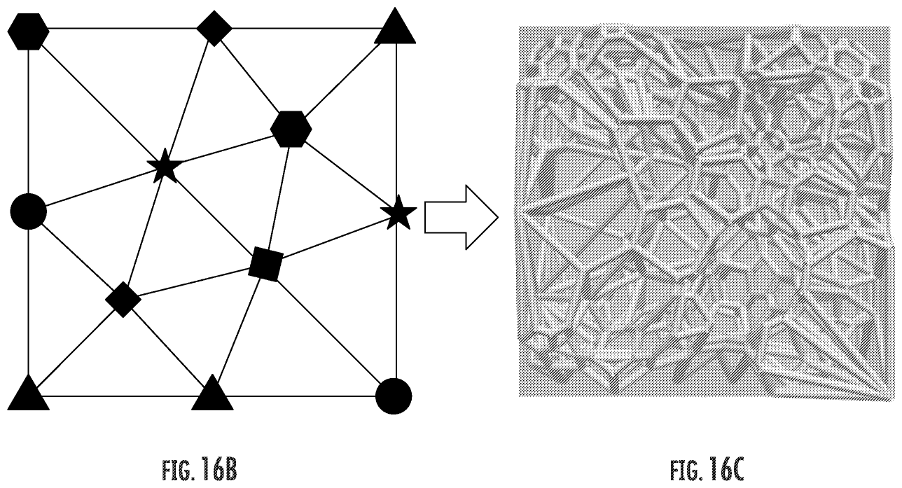

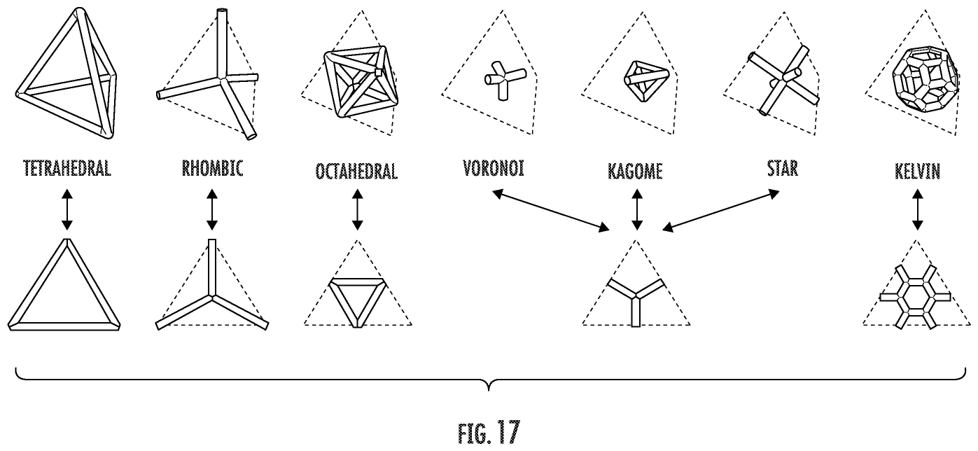

This approach may improve geometric connectivity by construction between adjacent tetrahedron cells within the tetrahedron mesh. In addition, it introduces the concept of “intracellular” transitions, which describes a method of enabling transitions to occur within a single tetrahedron cell. This is shown in FIG. 15, where two tetrahedron cells are assigned arbitrary cell types (possibly weighted) at each vertex, resulting in a non-symmetric transition structure within a single cell. In FIG. 16, an arbitrary set of cell types are assigned to every vertex of the depicted tetrahedron mesh. The resulting lattice generated displays geometric connectivity between all struts at the tetrahedron cell boundaries.

### Geometrically Compatible Triangle-Based Cell Types.

Lattice structures generated solely using tetrahedron-based cell types may have hanging struts (i.e. struts that stick out at the boundary without being connected to other struts). Hanging struts take on the appearance of a “diving board” and may have inferior aesthetic or mechanical properties. In addition, hanging struts may present a problem for certain manufacturing systems to fabricate. To address this issue, a geometrically-compatible set of triangle-based cell types is created. In FIG. 17, each of the tetrahedron-based primary cell type is matched to a corresponding triangle-based primary cell type. In some cases, multiple tetrahedron-based primary cell types may be matched to a single triangle-based primary cell type.

The triangle-based primary cell types can be treated just like the tetrahedron-based primary cell types in almost every way. For example, weighted combinations can be created to form weighted triangle-based cell types. In addition, intracellular transitions can be created within a single triangle by assigning a triangle-based cell type to every vertex of a triangle mesh. This also guarantees connectivity of struts between adjacent triangles in the mesh.

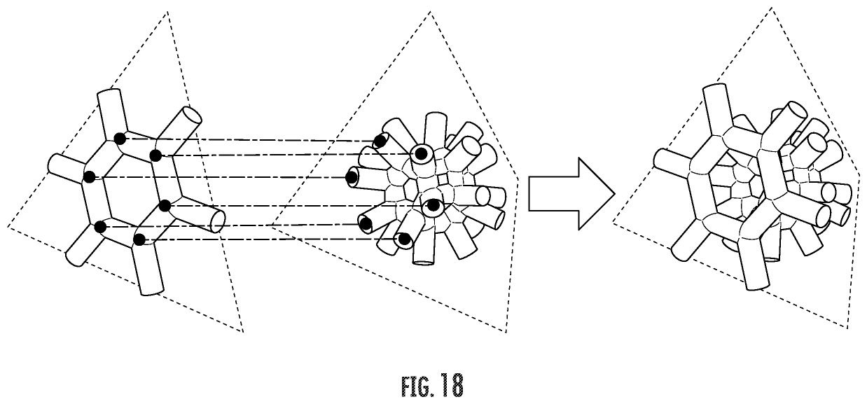

The primary use case of the triangle-based cell type is to act as a boundary lattice for a tetrahedron-based lattice structure to eliminate hanging nodes. Specifically, by applying a triangle-based lattice structure to boundary of the tetrahedron mesh, hanging nodes on the tetrahedron-based lattice will be automatically connected to corresponding nodes in the triangle-based lattice, as depicted in FIG. 18. The result is a combined lattice structure which may have improved aesthetic, mechanical, and printability properties.

In some embodiments, a tetrahedron and/or triangle mesh serves as a scaffold from which the lattice structure is generated, and each vertex in the mesh is assigned a cell type. The cell type may be a primary cell type or a weighted combination cell type. Assigning cell types to mesh vertices rather than mesh elements (i.e. the tetrahedrons and/or triangles themselves) facilitates that continuous transitions of the resulting lattice structure between all of the assigned cell types. That is, the resulting lattice structure will have connected struts at the boundaries between adjacent mesh elements.

To generate the entire lattice structure, an intracellular lattice transition structure is generated within each of the mesh elements. This process is independent for each mesh element and is the same for every mesh element, the focus will be on the generation process for a single mesh element. At the vertices of the mesh element are the previously assigned cell types. To generate the intracellular lattice structure, an interpolated cell type field using barycentric interpolation is first computed. This step can be mathematically expressed as:

$${w}_{i} = W * {b}_{i}$$

where wᵢ is the interpolated cell type, W is the cell type interpolation matrix (defined by the assigned cell types at the cell vertices), and bᵢ is the barycentric coordinate of some location within the cell. Next, the interpolated cell type field is used to compute the node locations of the lattice structure. The number of nodes are defined by the universal lattice structure described herein that all of the primary and weighted combination cells are derived from. This step can be mathematically expressed as:

$${b}_{i} = {B}_{i} * {w}_{i}$$

where bᵢ is the node location in barycentric conditions, Bᵢ is a node location interpolation matrix (defined by the family of *primary* cell types), and wᵢ is an interpolated cell type. Finally, a self-consistency condition is enforced by combining the two equations to get:

$${b}_{i} = {B}_{i} * W * {b}_{i}$$

This equation may be solved for bᵢ by various methods, including a fixed point iteration method. The solution bᵢ represents where to place node i of the lattice structure. Once every node location is computed in this manner, struts are generated between these computed node points using the strut connectivity prescribed by the universal lattice structure. The result is an intracellular transition structure that continuously transitions between the cell types assigned at the vertices, and the transitions occur within a single cell of the mesh. The entire lattice structure is generated by first generating an intracellular lattice structure for each cell in the mesh independently, then combining the results together to form a single lattice structure. The struts at the boundary of adjacent mesh cells are guaranteed to connect together due to the fact that the interpolated cell type field across the entire mesh is C0-continuous.

### G. Custom Mechanical Responses Using Spatially Varying Lattices

In some embodiments, multi-zonal lattices can vary in density and shape throughout a single part to deliver different characteristics in different zones. Embodiments according to the present invention enable various combinations of hybrid cell types from a relatively small number of primary cell types. The spatial distribution of these hybrid cell types may be controlled and tuned by a user such that the lattice structure transitions seamlessly among multiple cell types.

0For example, stretching-dominant cell types such as kagome offer excellent stiffness-to-mass ratio for lightweighting applications, while bending-dominant cell types such as voronoi and kelvin serve as excellent replacements for nonlinear foams. The constant-force response of certain cell types such as tetrahedral and icosahedral enable them to be used for cushioning applications. However, parts frequently need to be able to handle multiple deformation modes or require certain characteristics in specific locations. In other words, one cell type may not meet every requirement for a whole part.

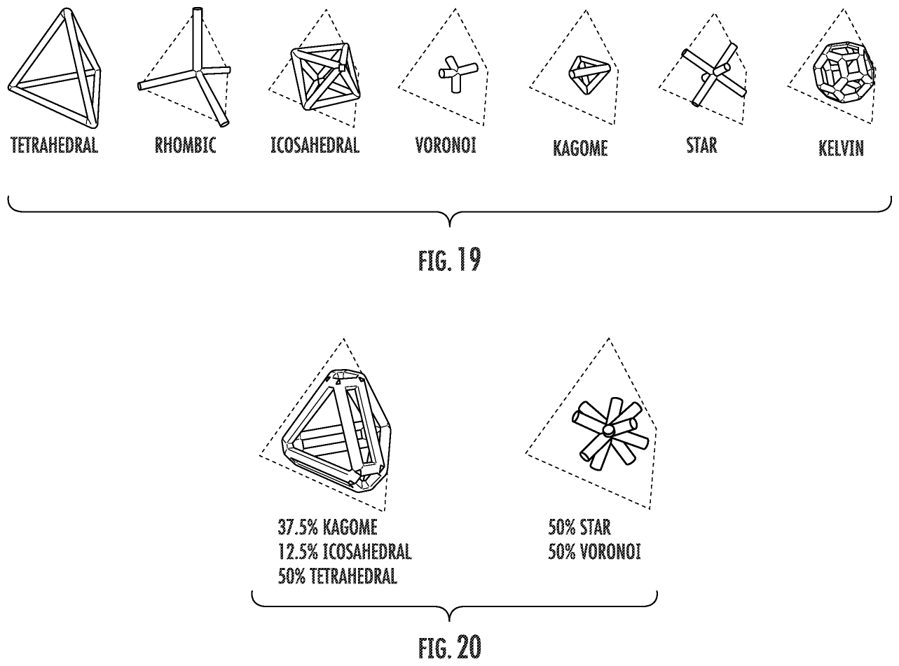

In some embodiments, the following primary cell types may be combined to form many different hybrid cell types: tetrahedral, rhombic, icosahedral, voronoi, kagome, star, and kelvin as shown in FIG. 19.

A hybrid cell type may be analogous to a recipe, with the primary cell types being the ingredients. Designers can mix and match any number of primary cell types in any desired ratio. The resulting hybrid cell may have aesthetic and mechanical characteristics similar to its primary cell type constituents. Two examples of hybrid cell types are depicted in FIG. 20.

A latticed part can be created from a single hybrid cell type, such as the pad shown in FIG. 21. However, cell transitions comes also have a potential advantage to create lattice structures with spatially varying cell types, which give the structure spatially varying mechanical behavior.

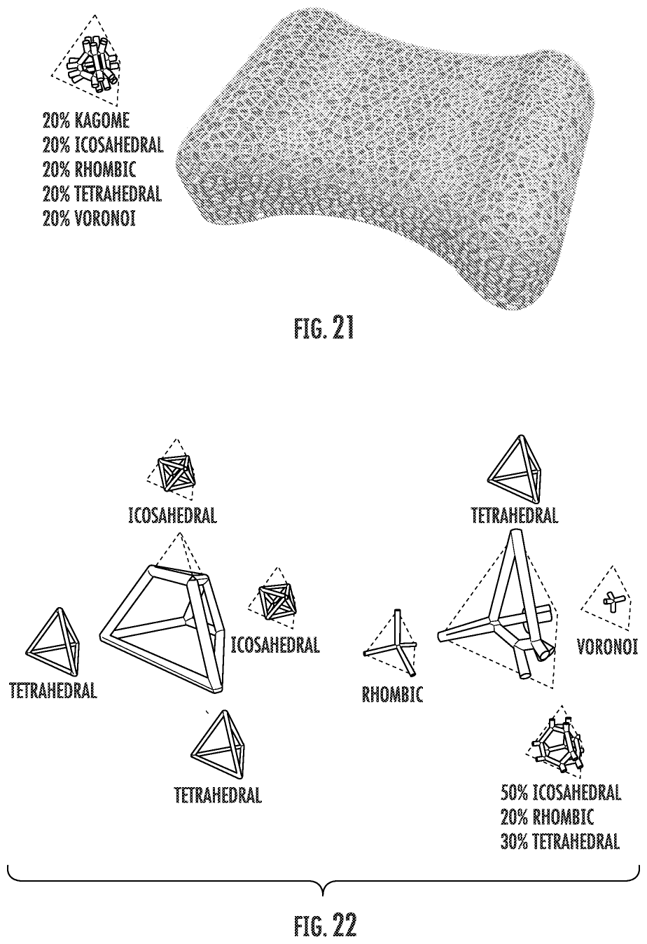

To achieve this, the concept of transition cells may be used. Transition cells are a lattice structure that transitions within a single cell. The transition cell may be created as described herein, such as by assigning each of the vertices of the tetrahedron cell a particular cell type, as depicted in FIG. 22. The assigned cell types at each of the vertices can be primary cell types or hybrid cell types. The assigned cell types at the vertices are then used to compute a transition cell structure. The transition cell resembles its four constituent cell types, especially near the respective vertices that each constituent cell type is assigned, yet the lattice structure continuously changes within the tetrahedron cell to transition between all four constituent cell types.

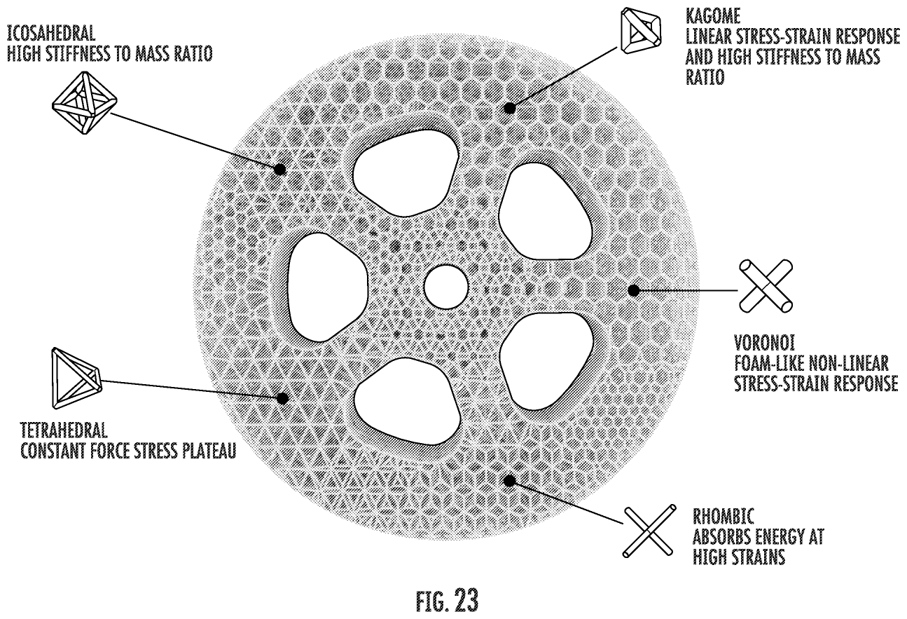

When multiple transition cells are joined together, the resulting lattice structure seamlessly assembles with no disconnects between struts. This makes it easy to generate complex structures with transitions between multiple cell types, such as the wheel lattice shown in FIG. 23.

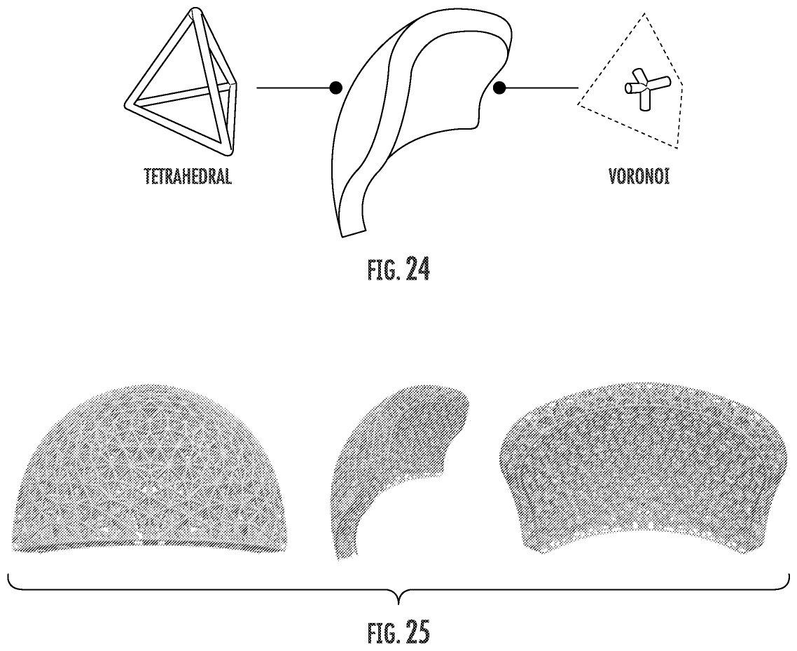

Transition cells can also be used to generate lattice structures with surface properties and aesthetics that are completely different from the interior of the three dimensional structure. For example, in FIGS. 24-25, the outer surface of the pad is assigned a tetrahedral cell type to achieve a uniform pattern and add stiffness to the surface, while the interior is assigned a voronoi cell type to provide more cushioning.

Example methods to prescribe cell types to define a particular spatial transition are provided below.

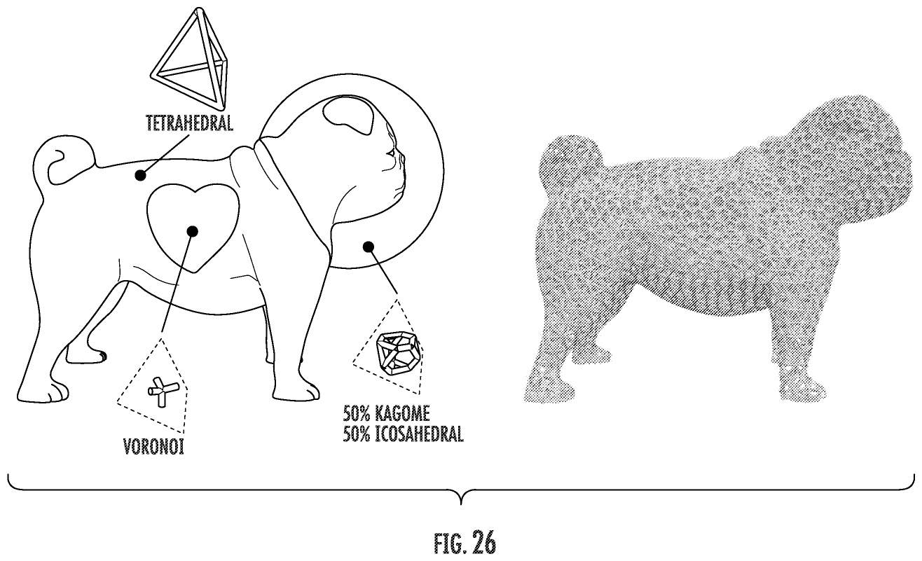

The first method is to create zones that define “transition regions” on the part (e.g., “zone-based transitions.” A zone comprises a mesh defining its boundaries, the cell type (primary or weighted) assigned to the zone, and a “transition distance” that determines how far from the zone spatially the zone affects the surrounding volume. There can be as few or as many zones as desired, and zones may overlap. The cell types assigned to tetrahedron vertices are computed from this collection of zones to form a latticed part with spatial transitions, as depicted in FIG. 26. As shown in FIG. 26, a lattice thre dimensional object in the shape of a pug dog has a heart shaped region and a spherical region that are assigned different cell types (Voronoi and 50% Kagome—50% icosahedral, respectively).

Using zones to define cell transitions provides a way to visualize and manipulate transitions to achieve a desired look, and is well suited for a graphical user interface.

The hybrid cell type (mathematically represented by the vector w) at any vertex in the scaffold tetrahedron mesh can be found as follows in a design with one zone:

$$w = c \cdot t + ( 1 - t ) \cdot b$$

Where “c” is the vector that contains the proportions of each of the assigned cell types for the zone. “t” is a scalar (0 . . . 1) that represents the relative distance of the tetrahedron vertex from the zone surface (e.g. 1 is inside the zone or on the zone boundary, 0 is exactly ‘transition distance’ from the zone surface). “b” represents the “background” cell type, if the vertex is outside the zone transition area.

The interpolation above is linear, but other functions may be selected (e.g. a sigmoid curve can smooth out the transitions near t=1 and t=0).

This approach can be generalized to 2 or more zones using the following:

$$w = {\sum }_{i = 1}^{n} \frac{1}{n} ( {C}_{i} \cdot {T}_{i} + ( 1 - {T}_{i} ) \cdot b )$$

where “n” is the number of zones within the zone ‘transition’ distance from the tetrahedron vertex. “Cᵢ” is the cell type assigned to the i-th zone. “Tᵢ” is a vector representing the relative distances of the tetrahedron vertex to the i-th zone. “b” represents the “background” cell type, if the vertex is outside the zone transition area.

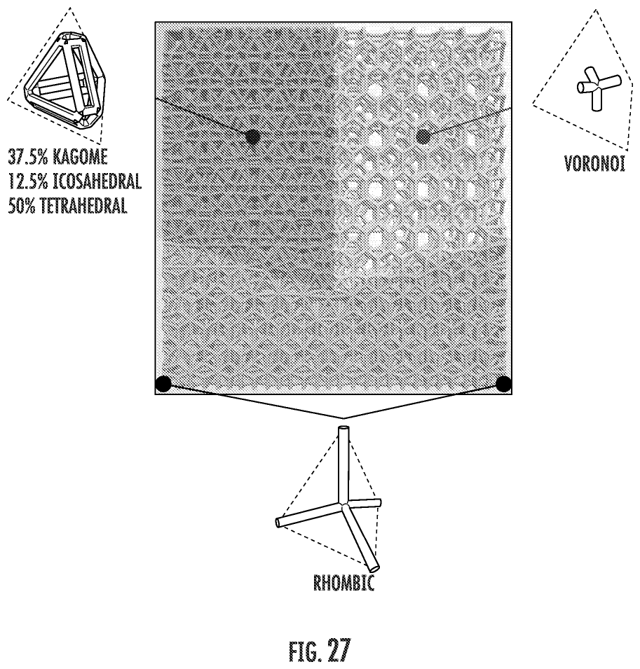

The second method to define transition regions is by creating a table of points denoting which cell type should be assigned at each point, e.g., point-based transitions. There can be as few or as many points and the points can be located anywhere relative to the design space. A cell type is then assigned to a particular tetrahedron vertex by finding the closest point in the table to the tetrahedron vertex. In essence, the cell types are assigned from the voronoi diagram of the table of points, as depicted in FIG. 27.

This method of defining cell transitions may be useful for working with discrete measurements, such as those from simulation tools, 3D scanners, and pressure mappings, allowing complex lattice structures to be generated directly from point data.

In addition, this method can be easily adapted to script workflows where a large number of part iterations will be generated.

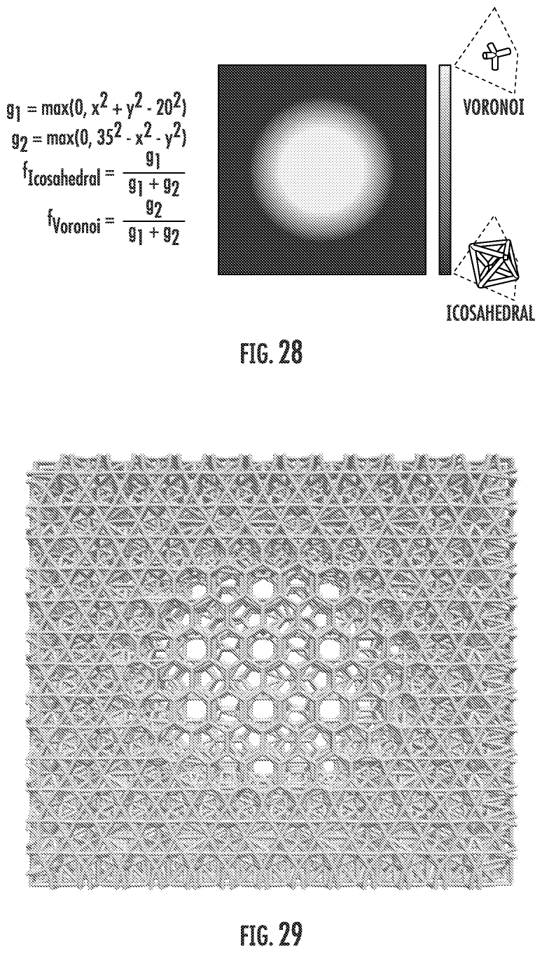

Finally, the third and last method is to define transition regions using mathematical equations, e.g., equation-based transitions. Each equation accepts x, y, and z coordinates as input and returns non-negative values as an output. An example of using equations to define cell transitions is the radial gradient lattice structure depicted in FIGS. 28-29. The spatial proportions of icosahedral and voronoi cell types are given by the functions ƒ_{Icosahedral} and ƒf_{Voronoi}, respectively. Note that defining transitions using a table of points can also be used to create lattice structures nearly identical to those defined by mathematical equations, as long as enough points are defined in the table.

Additional mechanical properties of transition lattices including tools to characterize mechanical properties under various loading conditions, from the small strain regime all the way to extremely large deformations, may be developed based on the lattice structures described herein.

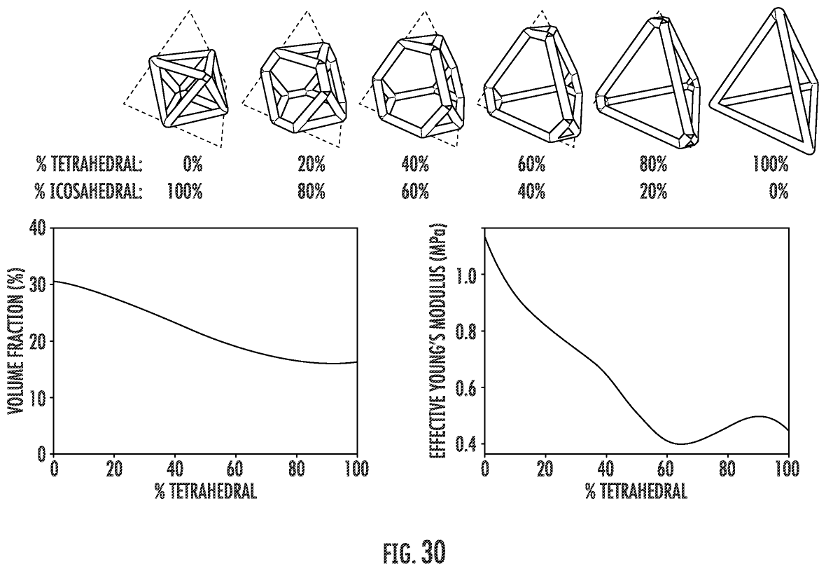

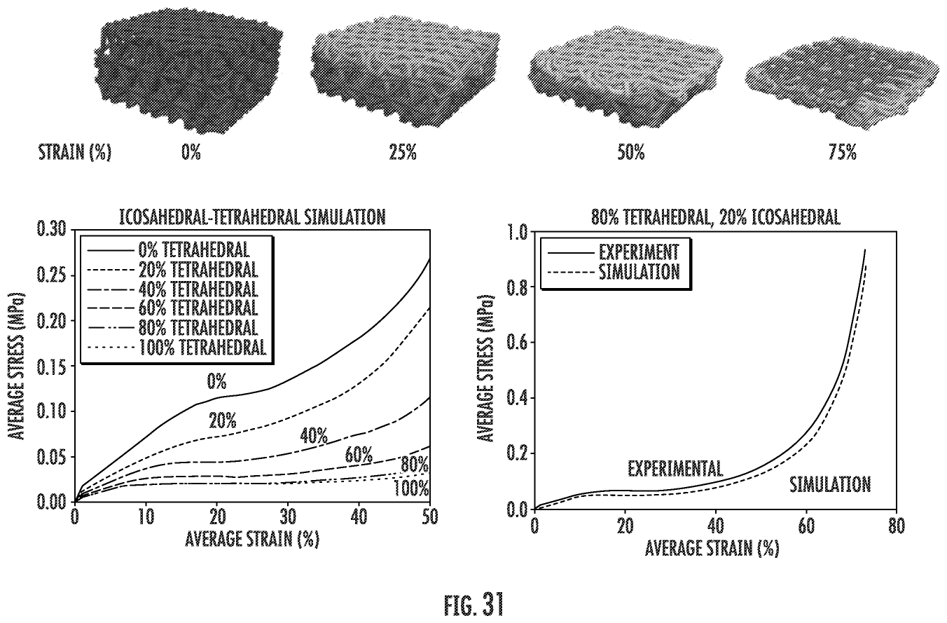

For example, FIG. 30 demonstrates the effect of changing the proportion of tetrahedral cells in a tetrahedral-icosahedral hybrid cell while holding constant other factors like strut diameter, cell size, test article material properties, and the underlying scaffold tetrahedron mesh of the test article. The volume fraction (left) and simulated effective Young's modulus (right) for EPU40 lattic epucks composed of tetrahedral-icosahedral hybrid cells are shown. hanging only the relative proportion of tetrahedral cell type in the hybrid cell can achieve near 2× changes in volume fraction and effective Young's modulus.

FIG. 40 demonstrates large deformation simulations performed on representative test articles with tetrahedral-icosahedral hybrid cells, showing a characteristic foam-like response composed of an initial stretching/bending-dominated deformation, followed by a plateau in stress caused by buckling, and finally a sharp increase in stress caused by densification due to strut-to-strut contact.

### H. Three-Dimensional (3D) Objects with Intracellular Transition Cells

Additively manufactured 3D objects as described herein can be produced by any of the processes and systems described herein, including the incorporation of intracellular transition cells. In some embodiments, the intermediate lattice unit cells of the transition regions described herein include (i) tetrahedrally symmetric transition cells, (ii) tetrahedrally asymmetric intracellular transition cells, or (iii) a combination of (i) and (ii). In particular embodiments, the tetrahedrally symmetric transition cells may include tetrahedrally symmetric extracellular transition cells.

An additively manufactured 3D product may include (a) a first zone comprising interconnected units of a first lattice unit cell; (b) a second zone comprising interconnected units of a second lattice unit cell; and (c) a first transition region between the first and second zone comprising intermediate lattice unit cells smoothly transitioning between both the zones, the intermediate lattice unit cells comprising tetrahedrally asymmetric intracellular transition cells. In some embodiments, each intracellular transition cell incudes a hybrid of at least two different primary unit cells. In some embodiments, each intracellular transition cell consists of a plurality of interconnected struts, and the struts of the intracellular transition cell are configured within a tetrahedral space defined by four vertices. A primary unit cell is assigned to each vertex, and at least two, three, or all four of the primary unit cells are different from one another. The struts of the intracellular transition cell may be defined by the struts of each primary cell projected into the tetrahedral space from each vertex. The struts of each primary cell may be fused, warped, lengthened, shortened, or a combination thereof, to form with one another a configuration of struts in the intracellular the transition cell within the tetrahedral space in which all struts thereof are connected.

Additively manufactured 3D products may include a smooth surface lattice cage comprised of struts connected to one another at nodes, with the nodes connected to struts of underlying unit cells that project towards the surface lattice cage.

In some embodiments, the lattice unit cells, including the primary cells, the intracellular transition cells, the cells of the first zone and the cells of the second zone are defined by or definable by a single universal lattice cell.

The objects described herein may be produced by the process of selective laser sintering (SLS), fused deposition modeling (FDM), stereolithography (SLA), three-dimensional printing (3DP), or multijet modeling (MJM).

In some embodiments, the additively manufactured 3D product comprises a conformal lattice. The additively manufactured 3d product may be formed of a polymer (including polymer blends), metal, ceramic, or composite thereof. The additively manufactured 3d product may be comprised of, consists of, or consists essentially of the reaction products of a dual cure polymer resin. The additively manufactured 3d product may be rigid, flexible, or elastic.

In some embodiments, the additively manufactured 3d product can be a brace, arm, link, shock absorber, cushion or pad (e.g., a bed or seat cushion; a wearable protective device such as a shin guard, knee pad, elbow pad, sports brassiere, bicycling shorts, backpack strap, backpack back pad (i.e. that pad or portion that rests against the wearer's back), neck brace, chest protector, protective vest, protective jacket, slacks, etc., including an insert therefor; an automotive or aerospace panel, bumper, or component; etc). In some embodiments, the additively manufactured 3d product can be a footwear insole, midsole, or orthotic insert, a bicycle saddle, or a helmet liner.

The foregoing is illustrative of the present invention, and is not to be construed as limiting thereof The invention is defined by the following claims, with equivalents of the claims to be included therein.

1. A computer-implemented method of making a three-dimensional (3D) lattice object, the lattice object comprising multiple zones of different lattice unit cells that smoothly transition between zones, the method comprising:
(a) providing a set of at least two primary unit cells and one universal unit cell,
(i) each primary and universal unit cell comprising a set of struts interconnected at nodes,
(ii) each primary unit cell in said set configured to smoothly transition to every other primary unit cell in said set through a series of intermediate unit cells,
(iii) and with all of said primary and intermediate unit cells defined by said universal unit cell;
(b) providing a 3D representation of the 3D lattice object;
(c) identifying at least a first and second zone in said 3D representation;
(d) at least partially filling said first zone with interconnected units of one of said primary or intermediate unit cells, and at least partially filling said second zone with interconnected units of a different one of said primary or intermediate unit cells, while leaving a first transition region between said zones; and
(e) filling said first transition region with a progressive series of intermediate unit cells, the struts of said intermediate cells in said progressive series gradually increasing or decreasing in length:
(i) as they approach the primary or intermediate unit cell contained in each respective zone, and
in conformance with the primary or intermediate unit cell contained in each respective zone,
to thereby create a 3D lattice object comprising multiple zones of different unit cells that smoothly transition between zones.

2. The method of claim 1, wherein:
step (c) includes identifying at least a first, second, and third zone in said 3D representation;
step (d) further includes filling said third zone with interconnected units of one of said primary or intermediate unit cells different from said interconnected units that at least partially fill said first and second zones, while leaving a second transition region between said second zone and said third zone; and
step (e) further includes filling said second transition region with said progressive series of intermediate unit cells.

3. The method of claim 2, wherein step (d) further includes leaving a third transition region between all of said first zone, said second zone, and said third zone, and step (e) further includes filling said third transition region with said progressive series of intermediate unit cells.

4. The method of claim 3, wherein said progressive series of intermediate unit cells in said third transition region varies along at least two distinct vectors or dimensions.

5. The method of claim 1, wherein said 3D representation comprises a mesh.

6. The method of claim 1, wherein said universal unit cell defines all of said primary and intermediate unit cells by (i) allowing struts in said universal unit cell to decrease in length to zero during said filling step (e), and (ii) allowing multiple struts in said universal unit cell to collapse directly into one another and form a single strut during said filling step (e).

7. The method of claim 1, wherein said step of identifying at least a first and second zone is carried out by:
(i) specifying at least one boundary in said 3D representation that defines each zone;
(ii) specifying at least one point in said 3D representation that defines each zone; or
(iii) a combination thereof

8. The method of claim 1, wherein said universal unit cell consists of (i) a truncated octahedron core having 36 struts interconnected at 24 nodes, and (ii) 24 arms, each node having an arm connected to and extending outward therefrom.

9. The method of claim 1 wherein said 3D lattice object comprises:
(i) a brace, arm, link, shock absorber, cushion or pad; or
(ii) a footwear insole, midsole, or orthotic insert, a bicycle saddle, or a helmet liner.

10. The method of claim 1, further comprising the step of additively manufacturing said 3D lattice object.

11. A computer program product for operating an electronic device comprising a non-transitory computer readable storage medium having computer readable program code embodied in the medium that when executed by a processor causes the processor to perform operations comprising claim 1.

12-37. (canceled)

38. An additively manufactured three dimensional (3D) lattice object formed using the method of claim 1.
